(19) United States
(12) Patent Application Publication
(10) Pub. No.: US 2026/0364674 A1
(43) Pub. Date: Nov. 19, 2026

(54) OXYGEN OPENING DEVICE

(71) Applicant: NIPPON STEEL CORPORATION, Tokyo (JP)

(72) Inventors: Hiroki MAEGAWA, Tokyo (JP); Yukihiro MATSUOKA, Tokyo (JP)

(21) Appl. No.: 19/148,421

(22) PCT Filed: Jan. 24, 2024
(86) PCT No.: PCT/JP2024/002107

§ 371 Date: Jul. 16, 2025

(30) Foreign Application Priority Data
Jan. 25, 2023 (JP) 2023-009378

(51) Int. Cl. B22D 41/58; B22D 11/18

(52) U.S. Cl. CPC B22D 41/58; B22D 11/18

(57) ABSTRACT

An oxygen opening device includes: a conveying device configured to convey an oxygen lance pipe for supplying oxygen so as to place a tip portion of the oxygen lance pipe at a pouring hole provided below a ladle for molten steel and at a position heated by a heat source located away from the pouring hole; an ignition control unit configured to control the conveying device so as to place the tip portion at the position heated by the heat source for ignition; and an opening control unit configured to control the conveying device so as to place the ignited tip portion into the pouring hole to open the pouring hole that is blocked.

### TECHNICAL FIELD The present disclosure relates to an oxygen opening device.

### BACKGROUND ART

Patent Literature 1 discloses an automatic oxygen opening device. The automatic oxygen opening device includes a pipe feeding device, a tilting device, a swiveling device, and an oxygen supply device. The pipe feeding device has a winding drum around which an oxygen injection pipe is wound, a feeding roll that continuously feeds the oxygen injection pipe by unwinding it from the winding drum, and a pipe guide that guides the oxygen injection pipe into a sliding gate nozzle from below. The tilting device tilts the pipe feeding device in a vertical direction. The swiveling device swivels the pipe feeding device in a horizontal direction. The oxygen supply device supplies oxygen gas to the oxygen injection pipe.

### CITATION LIST

### Patent Literature

[Patent Literature 1] Japanese Unexamined Patent Publication No. H6-182526

### SUMMARY OF INVENTION

### Technical Problem

The present disclosure provides an oxygen opening device beneficial for opening, with high reliability and in a timely manner, a pouring hole of a ladle that has become blocked.

### Solution to Problem

An oxygen opening device according to one aspect of the present disclosure includes: a conveying device configured to convey an oxygen lance pipe for supplying oxygen so as to place a tip portion of the oxygen lance pipe at a pouring hole provided below a ladle for molten steel and at a position heated by a heat source located away from the pouring hole; an ignition control unit configured to control the conveying device so as to place the tip portion at the position heated by the heat source for ignition; and an opening control unit configured to control the conveying device so as to place the ignited tip portion into the pouring hole to open the pouring hole that is blocked.

If the blocked pouring hole is not opened in a timely manner, molten steel in the ladle may solidify without being discharged and, in some cases, it may become necessary to discard all the molten steel and even the ladle itself. Thus, the task of opening the pouring hole is critical. According to the present device, the oxygen lance pipe that has been ignited in advance is inserted into the pouring hole. Accordingly, the pouring hole is opened in a timely manner by continued combustion of the oxygen lance pipe inside the pouring hole without waiting for ignition inside the pouring hole. Therefore, the pouring hole can be reliably opened in a timely manner with high reliability without being influenced by remaining thermal energy inside the pouring hole.

The ignition control unit may be configured to control the conveying device so as to place the tip portion at the position heated by a heat source using molten steel stored outside the ladle as the heat source. By efficiently using the heat of the molten steel for igniting the tip portion, the device structure can be simplified.

An ignition device disposed around the ladle may also be provided, and the ignition control unit may be configured to control the conveying device so as to place the tip portion at the position heated by the heat source, using the ignition device as the heat source. Even in a situation where the amount of the molten steel is small and it is difficult to place the tip portion in the molten steel, the tip portion can be ignited.

A ladle shroud for guiding the molten steel discharged from the pouring hole may be attached below the pouring hole, and the opening control unit may be configured to control the conveying device so as to place the ignited tip portion at a standby position adjacent to the ladle shroud with the tip portion oriented upward, and to place the ignited tip portion into the pouring hole after removal of the ladle shroud. Once the ladle shroud is removed, the oxygen lance pipe can be quickly inserted into the pouring hole and the pouring hole can be opened more rapidly.

A second conveying device configured to convey the ladle shroud for guiding molten steel discharged from the pouring hole between a mounting position below the pouring hole and a retracted position retracted from the mounting position may be further provided. This allows operations pertaining to the ladle shroud and operations pertaining to the oxygen lance pipe to be performed in parallel. Accordingly, the pouring hole can be opened more quickly.

A blockage detection unit configured to detect blockage of the pouring hole based on a state of a gate for opening and closing the pouring hole and a change in weight of a tundish for accommodating the molten steel guided by the ladle shroud may be further provided, and the ignition control unit may be configured to control the conveying device so as to place the tip portion at the heat source after the blockage detection unit detects blockage of the pouring hole and before the second conveying device retracts the ladle shroud from the mounting position. By performing in parallel the operation of igniting the tip portion and the operation of retracting the ladle shroud, the time from detection of blockage to opening of hole can be further shortened.

The opening control unit may be configured to control the conveying device so as to: place the ignited tip portion at the standby position adjacent to the ladle shroud with the ignited tip portion oriented upward before the second conveying device retracts the ladle shroud from the mounting position; and place the ignited tip portion into the pouring hole after the second conveying device retracts the ladle shroud from the mounting position. Thus, the ignited oxygen lance pipe can be inserted even more quickly after the ladle shroud is retracted.

A sensor configured to acquire three-dimensional data of the pouring hole from outside the ladle and a position detection unit configured to detect a position of the pouring hole based on the three-dimensional data acquired by the sensor may be further provided, and the opening control unit may be configured to place the tip portion in the pouring hole based on the position of the pouring hole detected by the position detection unit. The oxygen lance pipe can be inserted into the pouring hole with high accuracy.

A second sensor configured to acquire image data of the ignited tip portion and a combustion detection unit configured to detect whether combustion of the tip portion is continuing based on the image data acquired by the second sensor may be further provided, and, the ignition control unit may be configured to control the conveying device so as to relocate the tip portion to the position heated by the heat source when the combustion detection unit detects that the tip portion is not continuing to combust. Insertion of the oxygen lance pipe in a state where the tip portion is ignited can be executed more reliably.

The conveying device may include: a lance holding portion configured to hold the oxygen lance pipe; a base portion fixed below and around the ladle; and a multi-joint arm connecting the lance holding portion to the base portion and configured to change a position and posture of the lance holding portion relative to the base portion. Thus, both the ignition and opening operations can be readily implemented by a single device.

A force sensor provided at the lance holding portion may be further provided, and the opening control unit may be configured to control the conveying device, based on a detection result of the force sensor, so as to insert the tip portion into the pouring hole while limiting thrust force of the tip portion toward the inside of the pouring hole. Damage to the lining inside the pouring hole due to collision with the oxygen lance pipe can be readily avoided.

The opening control unit may be configured to: control the conveying device so as to bring the tip portion into contact with multiple points on the inner surface of the pouring hole with the tip portion inserted to a first depth in the pouring hole; calculate a center position of the pouring hole based on positions of the tip portion when contacting the plurality of points; control the conveying device so as to align a center position of the tip portion with that center position of the pouring hole; and control the conveying device so as to insert the tip portion to a second depth deeper than the first depth. By aligning the center position of the tip portion with the center position of the pouring hole in a state where the tip portion is inserted to the first depth, damage such as breakage of the lining during the process until the tip portion reaches the second depth can be avoided more reliably.

A rack for accommodating a plurality of oxygen lance pipes at a position away from under the ladle, and a lance replacement control unit configured to control the conveying device so as to place a used oxygen lance pipe into the rack, and to control the conveying device so as to have the lance holding portion hold an unused oxygen lance pipe stored in the rack may be further provided. By automating the replacement of the oxygen lance pipe attached to the lance holding portion, further labor savings can be achieved in the oxygen opening operation.

### Advantageous Effects of Invention

According to the present disclosure, an oxygen opening device beneficial for opening, with high reliability and in a timely manner, a pouring hole of a ladle that has become blocked can be provided.

### BRIEF DESCRIPTION OF DRAWINGS

FIG. 1 is a schematic diagram illustrating an example configuration of a continuous casting system.

FIG. 2 is a block diagram illustrating an example functional configuration of a control system.

FIG. 3 is a block diagram illustrating an example hardware configuration of the control system.

FIG. 4 is a flowchart illustrating an example pouring procedure from a ladle to a tundish.

FIG. 5 is a flowchart illustrating an example oxygen opening procedure.

FIG. 6 is a schematic diagram illustrating an example state in which an oxygen lance pipe is being ignited.

FIG. 7 is a schematic diagram illustrating an example state in which retraction of a ladle shroud is awaited.

FIG. 8 is a flowchart illustrating an example oxygen opening procedure.

FIG. 9 is a schematic diagram illustrating an example state in which insertion operation of the oxygen lance pipe has started.

FIG. 10 is a flowchart illustrating an example oxygen opening procedure.

FIG. 11 is a flowchart illustrating an example position adjustment procedure of the oxygen lance pipe.

FIG. 12 is a schematic diagram illustrating an example relationship between the position of the tip portion in the position adjustment procedure and the center position of the pouring hole.

### DESCRIPTION OF EMBODIMENTS

Embodiments will be described in detail below with reference to the drawings. In the descriptions, the same reference numerals indicate elements having the same or equivalent functions, and repeated descriptions are omitted.

### Continuous Casting System

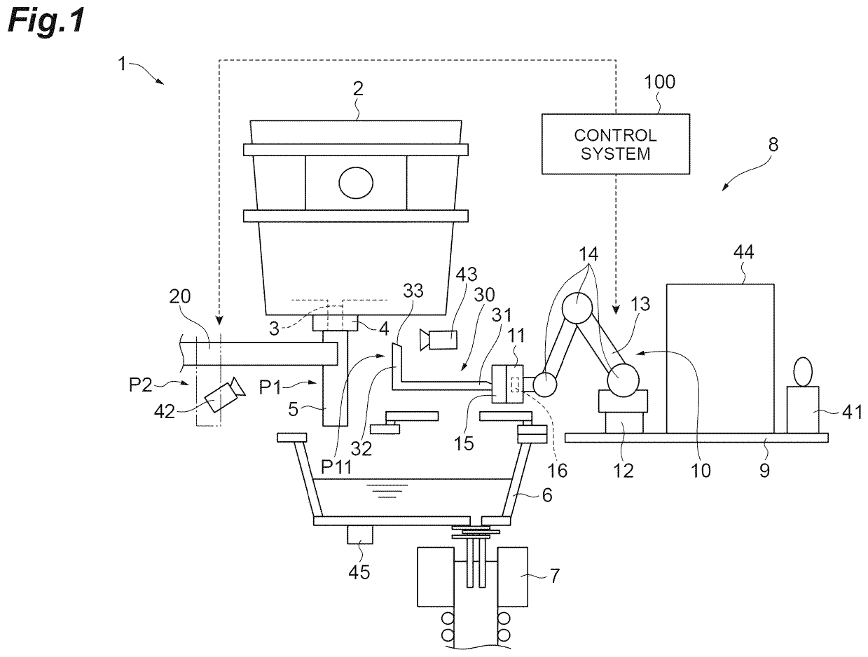

FIG. 1 is a schematic diagram illustrating an example configuration of a continuous casting system. A continuous casting system 1 illustrated in FIG. 1 is a system for producing steel slabs by continuous caster. The continuous casting system 1 includes a ladle 2, a pouring hole 3, a gate 4, a ladle shroud 5, a tundish 6, a mold 7, and an oxygen opening device 8. The ladle 2 contains molten steel generated in a blast furnace or an electric furnace. The ladle 2 has, in its lower part, the pouring hole 3 and the gate 4. The pouring hole 3 discharges molten steel downward. The gate 4 opens and closes the pouring hole 3.

The ladle shroud 5 guides downward the molten steel discharged from the pouring hole 3. The tundish 6 receives the molten steel guided from above by the ladle shroud 5, and discharges it downward. The mold 7 receives the molten steel discharged from above by the tundish 6, molds it, and sends it downward. While passing through the mold 7, the molten steel gradually solidifies. The molten steel that has passed through the mold 7 and is sent downward is conveyed by multiple conveyance rolls and cut into slabs by a gas cutting machine or the like.

The oxygen opening device 8 is a device configured to place a tip portion 33 of an oxygen lance pipe 30, which supplies oxygen, into the pouring hole 3 if the pouring hole 3 becomes blocked by highly viscous or solidified molten steel in the ladle 2, thereby opening the pouring hole 3 with the combustion heat of the oxygen lance pipe 30. Because the oxygen opening device 8 performs, on behalf of an operator, the task of opening the pouring hole 3 with the oxygen lance pipe 30, the burden on the operator is significantly reduced.

The oxygen opening device 8 includes a conveying device 10 that conveys the oxygen lance pipe 30, and a control system 100 that controls the conveying device 10. In continuous casting, if a blocked pouring hole 3 is not opened in a timely manner, molten steel in the ladle 2 may solidify without being discharged, in some cases making it unavoidable to discard all of the molten steel in the ladle 2 and the ladle 2 itself. Accordingly, the task of opening the pouring hole 3 is critical.

Therefore, the conveying device 10 is configured to convey the oxygen lance pipe 30 so as to place the tip portion 33 in the pouring hole 3 and at a position heated by a heat source located away from the pouring hole 3. The control system 100 is configured to execute: controlling the conveying device 10 so as to place the tip portion 33 at the heat source for ignition; and controlling the conveying device 10 so as to place the ignited tip portion 33 into the pouring hole 3 to open the blocked pouring hole 3.

This allows the oxygen lance pipe 30, which has already been ignited in advance, to be inserted into the pouring hole 3. Thus, without waiting for ignition inside the pouring hole 3, the pouring hole 3 can be opened timely by the continued combustion of the oxygen lance pipe 30 inside the pouring hole 3. Therefore, the pouring hole 3 can be opened with high reliability on time without being influenced by the remaining heat inside the pouring hole 3.

The conveying device 10 may be configured in any manner as long as it is able to place the tip portion 33 in the pouring hole 3 and at a heat source located away from the pouring hole 3. As an example, the conveying device 10 illustrated in FIG. 1 is configured as a serial-link vertical multi-joint robot. For instance, the conveying device 10 includes a lance holding portion 11, a base portion 12, and a multi-joint arm 13.

The lance holding portion 11 holds the oxygen lance pipe 30. For example, the lance holding portion 11 may be a master of an auto tool changer that holds a tool adapter 15 pre-attached to the oxygen lance pipe 30. For instance, the oxygen lance pipe 30 may include a support portion 31 extending from the tool adapter 15 and an insertion portion 32 that is bent relative to the support portion 31. The support portion 31 is connected, via a hose or the like (not illustrated), to an oxygen supply source, and oxygen is supplied from the support portion 31 to the insertion portion 32 through the oxygen lance pipe 30. Oxygen guided into the insertion portion 32 is ejected from the end of the insertion portion 32. In this configuration, the end of the insertion portion 32 is the tip portion 33 of the oxygen lance pipe 30. The lance holding portion 11 is configured to switch between a locked state, in which the tool adapter 15 is held, and an unlocked state, in which the tool adapter 15 is released, in response to a control signal.

The base portion 12 is fixed around and below the ladle 2. For example, the base portion 12 may be fixed on a stage 9 provided around the tundish 6 located below the ladle 2. The multi-joint arm 13 extends so as to connect the lance holding portion 11 to the base portion 12, and changes the position and the posture of the lance holding portion 11 relative to the base portion 12 by means of multiple joint axes.

The multi-joint arm 13 has multiple drive shafts 14 to drive the multiple joint axes. As one example, the multi-joint arm 13 has six drive shafts 14 so as to change the position of the lance holding portion 11 in three mutually perpendicular directions and to change the posture of the lance holding portion 11 about those three directions.

In this way, with the conveying device 10 configured as a multi-joint robot, two operations ignition and opening can be performed readily by a single device. As noted above, the conveying device 10 is not limited to a vertical multi-joint robot. For example, the conveying device 10 may be configured with a so-called SCARA-type robot along with a lifting actuator that moves the oxygen lance pipe 30 up and down and a rotary actuator that rotates the oxygen lance pipe 30 so as to change the orientation of the tip portion 33. The conveying device 10 may be configured with an XY-table that moves the oxygen lance pipe 30 horizontally, a lifting actuator that moves the oxygen lance pipe 30 up and down, and a rotary actuator that rotates the oxygen lance pipe 30 so as to change the orientation of the tip portion 33.

The continuous casting system 1 may be further provided with an ignition device 41 as the above-mentioned heat source. The ignition device 41 is arranged around the ladle 2. For example, the ignition device 41 is arranged below the ladle 2, around the tundish 6. As one example, the ignition device 41 is arranged on the stage 9.

For instance, the ignition device 41 may be a burner that produces a flame by gas. The position heated by the ignition device 41 is within the flame generated by the ignition device 41. The ignition device 41 may also be an induction heating device that heats the tip portion 33 by electromagnetic induction using a coil. In that case, the position heated by the ignition device 41 is inside the coil. The ignition device 41 may also be a grinder that heats the tip portion 33 by friction. In that case, the position heated by the ignition device 41 is the position for contacting the grinder.

The continuous casting system 1 may further include a sensor 42. The sensor 42 acquires three-dimensional data of the pouring hole 3 from outside the ladle 2. For example, the sensor 42 may acquire three-dimensional data of the pouring hole 3 that opens outside the ladle 2 through the gate 4. Three-dimensional data is data representing the three-dimensional shape of objects arranged in a three-dimensional space as point sequences or the like in three-dimensional space. The three-dimensional data acquired by the sensor 42 can be used for position adjustment of the tip portion 33 relative to the pouring hole 3.

For example, the sensor 42 may be a Time-of-Flight (TOF) camera. A TOF camera detects, for each pixel, a distance to an object being imaged based on the time from when light is emitted toward the object until the light is reflected by the object and enters an imaging unit. The TOF camera acquires distance image data that includes, on a per-pixel basis, distance information to the object, as three-dimensional data.

The sensor 42 may be any type of sensor as long as it can acquire three-dimensional data. For example, the sensor 42 may be a stereo camera or a three-dimensional shape sensor that uses laser scanning. The sensor 42 may also acquire, as three-dimensional data, the position/posture of a marker for image recognition whose relative position to the pouring hole 3 is known. Because the position/posture of the pouring hole 3 can be derived from the position/orientation of a marker whose position/posture relative to the pouring hole 3 is known, the position/posture of the marker is also included in three-dimensional data of the pouring hole 3. The sensor 42 may be fixed to a part whose position/posture is changed by the conveying device 10 (for example, the lance holding portion 11). In that case, by changing the position/posture of the sensor 42 with the conveying device 10, the sensor 42 can be used for acquiring three-dimensional data of various targets. Moreover, by combining three-dimensional data from multiple viewpoints, the position of the pouring hole 3 can be recognized more accurately.

The continuous casting system 1 may further include a second sensor 43. The second sensor 43 acquires image data of the ignited tip portion 33. The second sensor 43 may be, for example, a black-and-white visible-light camera or a color visible-light camera. For example, the second sensor 43 is placed so as to be able to capture the tip portion 33 placed at a standby position P11 next to the ladle shroud 5, with the tip portion 33 oriented upward waiting for the ladle shroud 5 to be retracted. The image data acquired by the second sensor 43 can be used, for instance, to detect that the tip portion 33 has stopped burning during the wait for retraction of the ladle shroud 5 and that the tip portion 33 needs to be re-ignited. Note that the second sensor 43 may be fixed to a part whose position/posture is changed by the conveying device 10 (for example, the lance holding portion 11). In this case, by changing the position/posture of the second sensor 43 with the conveying device 10, the second sensor 43 can be used to acquire image data of various targets. Blind spots of the second sensor 43 can be reduced and the state of the tip portion 33 can be detected with higher reliability.

The continuous casting system 1 may be further provided with a force sensor 16. The force sensor 16 detects the force exerted on the oxygen lance pipe 30. The force sensor 16 detects at least the force acting on the oxygen lance pipe 30 along the insertion portion 32. The force sensor 16 may further detect the force acting on the oxygen lance pipe 30 in a direction intersecting the insertion portion 32.

For example, the force sensor 16 is provided at the lance holding portion 11. Examples of the force sensor 16 include strain-gauge load cells.

The continuous casting system 1 may further include a rack 44. The rack 44 accommodates a plurality of oxygen lance pipes 30 at a position away from below the ladle 2. For example, the rack 44 may be arranged on the stage 9. Each of the multiple oxygen lance pipes 30 stored in the rack 44 may be pre-fitted with a tool adapter 15. This enables the conveying device 10 to perform the operation of replacing a used oxygen lance pipe 30 with a new oxygen lance pipe 30.

The rack 44 may be divided into a used-lance rack that accommodates used oxygen lance pipes 30 and an unused-lance rack that accommodates unused oxygen lance pipes 30. The used-lance rack and the unused-lance rack may be adjacent to each other, arranged one above the other, or spaced apart from each other.

The continuous casting system 1 may further include a weight sensor 45. The weight sensor 45 detects the weight of the tundish 6. The detection result by the weight sensor 45 can be used for detecting blockage of the pouring hole 3 or the like.

The continuous casting system 1 may further include a second conveying device 20. The second conveying device 20 conveys the ladle shroud 5 between a mounting position P1 below the pouring hole 3 and a retracted position P2 that is retracted from the mounting position P1. The retracted position P2 is located around and below the ladle 2. For example, the second conveying device 20 conveys the ladle shroud 5 between the mounting position P1 and the retracted position P2 along an arc-shaped path by rotating around a vertical axis at a position away from below the ladle 2.

By providing the second conveying device 20 that conveys the ladle shroud 5 separately from the continuous casting system 1 that conveys the oxygen lance pipe 30, operations related to the ladle shroud 5 and operations related to the oxygen lance pipe 30 can be performed in parallel. Therefore, the pouring hole 3 can be opened more quickly.

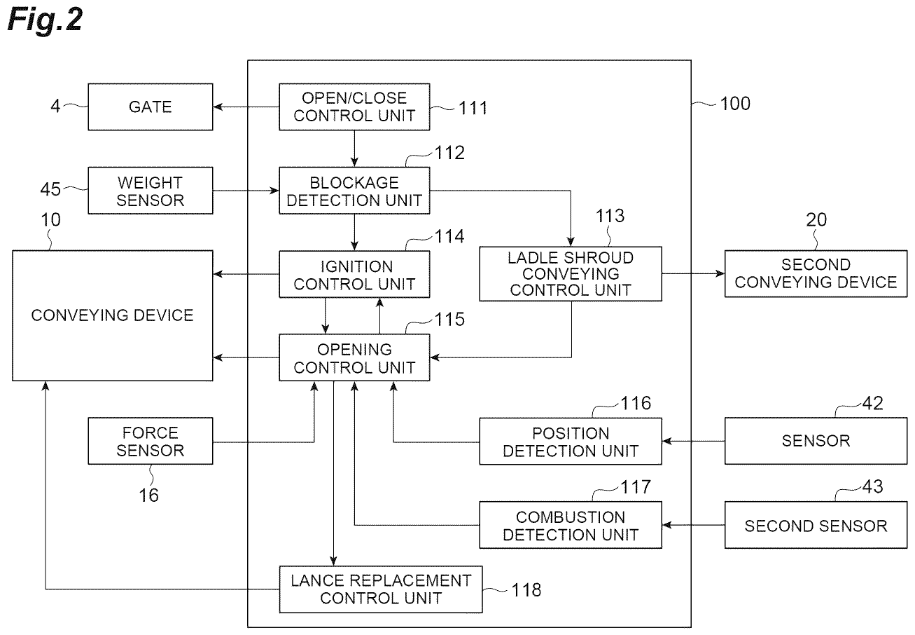

FIG. 2 is a block diagram illustrating an example configuration of the control system. As illustrated in FIG. 2, the control system 100 includes an open/close control unit 111, a blockage detection unit 112, a ladle shroud conveying control unit 113, an ignition control unit 114, and an opening control unit 115 as functional components (hereinafter referred to as “functional blocks”).

The open/close control unit 111 opens and closes the gate 4. The blockage detection unit 112 detects blockage of the pouring hole 3 based on the state of the gate 4 and a change in weight of the tundish 6. Here, “blockage” means a state in which the flow of molten steel from the pouring hole 3 is completely or substantially obstructed by molten steel or the like that has become highly viscous or solidified even though the gate 4 opens the pouring hole 3. For example, the blockage detection unit 112 acquires information on the state of the gate 4 from the open/close control unit 111 and acquires information on the weight of the tundish 6 from the weight sensor 45. After the gate 4 opens the pouring hole 3, the blockage detection unit 112 acquires a plurality of time-series detection results from the weight sensor 45 and calculates the amount of weight change of the tundish 6 per unit time based on the plurality of detection results. The blockage detection unit 112 detects blockage of the pouring hole 3 when the calculated weight change is smaller than a predetermined threshold. The threshold is set in advance to be lower than the weight change that would be expected in the absence of blockage in the pouring hole 3.

The ladle shroud conveying control unit 113 causes the second conveying device 20 to convey the ladle shroud 5 between the mounting position P1 and the retracted position P2. For example, before the open/close control unit 111 causes the gate 4 to open the pouring hole 3, the ladle shroud conveying control unit 113 causes the second conveying device 20 to place the ladle shroud 5 at the mounting position P1. After the open/close control unit 111 causes the gate 4 to open the pouring hole 3, if the blockage detection unit 112 detects blockage of the pouring hole 3, the ladle shroud conveying control unit 113 causes the second conveying device 20 to retract the ladle shroud 5 from the mounting position P1 to the retracted position P2.

The ignition control unit 114 controls the conveying device 10 so as to place the tip portion 33 at a position heated by the heat source for ignition. For example, the ignition control unit 114 controls the conveying device 10 so as to move the lance holding portion 11 to a predetermined target position and target posture such that the tip portion 33 is placed at the position heated by the heat source. For example, the ignition control unit 114 calculates operation angles for the multiple drive shafts 14, using inverse kinematics or the like, to move the lance holding portion 11 from its current position and posture to the target position and target posture, and operates the multiple drive shafts 14 according to the calculated results.

The ignition control unit 114 may control the conveying device 10 so as to place the tip portion 33 at a position heated by the heat source, using molten steel stored outside the ladle 2 as the heat source. For example, the ignition control unit 114 may control the conveying device 10 so as to place the tip portion 33 near the molten steel held in the tundish 6 or in the molten steel held in the tundish 6. By utilizing the heat of the molten steel for igniting the tip portion 33, the device structure can be simplified.

The ignition control unit 114 may control the conveying device 10 so as to place the tip portion 33 at a position heated by the heat source, using the ignition device 41 as the heat source. Even in a situation where there is a small amount of molten steel in, for instance, the tundish 6 and it is difficult to place the tip portion 33 near or in the molten steel, the tip portion 33 can still be ignited.

If the ignition device 41 is a burner, the ignition control unit 114 controls the conveying device 10 so as to place the tip portion 33 in the flame generated by the ignition device 41. If the ignition device 41 is an induction heating device, the ignition control unit 114 controls the conveying device 10 so as to place the tip portion 33 inside the coil. If the ignition device 41 is a grinder, the ignition control unit 114 controls the conveying device 10 so as to place the tip portion 33 at a position that contacts the grinder.

The opening control unit 115 controls the conveying device 10 so as to place the ignited tip portion 33 inside the pouring hole 3 to open the blocked pouring hole 3. For example, the opening control unit 115 controls the conveying device 10 so that the insertion portion 32 is inserted into the pouring hole 3, thereby placing the ignited tip portion 33 in the pouring hole 3. The combustion heat in the pouring hole 3 dissolves the molten steel that has become highly viscous or solidified and the blockage of the pouring hole 3 is removed.

The opening control unit 115 may control the conveying device 10 so that the ignited tip portion 33 is oriented upward and placed at the standby position P11 next to the ladle shroud 5, and, after the ladle shroud 5 is removed, so that the tip portion 33 is placed into the pouring hole 3. For example, the opening control unit 115 controls the conveying device 10 so that the lance holding portion 11 is moved to a predetermined first target position and first target posture, in which the support portion 31 extends horizontally from the end of the tool adapter 15 to a position under the standby position P11, the insertion portion 32 extends upward from the end of the support portion 31, and the tip portion 33 is placed at the standby position P11. For instance, the opening control unit 115 calculates operation angles for the multiple drive shafts 14, using inverse kinematics or the like, to move the lance holding portion 11 from its current position and posture to the first target position and the first target posture, and operates the multiple drive shafts 14 according to the calculated results. Note that the orientation of the tip portion 33 at the standby position P11 may not be limited to be upward. For example, the opening control unit 115 may control the conveying device 10 so that the tip portion 33 is oriented horizontally at the standby position P11.

After removal of the ladle shroud 5, the opening control unit 115 controls the conveying device 10 to move the lance holding portion 11 to the second target position and the second target posture, predetermined so that the upwardly oriented tip portion 33 is positioned to extend toward the center of the pouring hole 3 from below. For instance, the opening control unit 115 calculates operation angles for the multiple drive shafts 14 for moving the lance holding portion 11 from the first target position and the first target posture to the second target position and the second target posture, using inverse kinematics or the like, and operates the multiple drive shafts 14 according to the calculated results.

Subsequently, the opening control unit 115 controls the conveying device 10 to move the lance holding portion 11 linearly to the third target position and the third target posture that are predetermined to insert the insertion portion 32 into the pouring hole 3 and place the tip portion 33 inside the pouring hole 3. For instance, the opening control unit 115 calculates operation angles for the multiple drive shafts 14 for moving the lance holding portion 11 from the current position and the current posture to the third target position and the third target posture, using inverse kinematics or the like, and operates the multiple drive shafts 14 according to the calculated results.

By orienting the ignited tip portion 33 upward and placing the tip portion 33 at the standby position P11 while waiting for removal of the ladle shroud 5, the oxygen lance pipe 30 can be inserted into the pouring hole 3 quickly after the ladle shroud 5 is removed, thus opening the pouring hole 3 more quickly. Here, removal of the ladle shroud 5 means, for example, retracting the ladle shroud 5 from below the pouring hole 3 to a position that allows insertion of the oxygen lance pipe 30 into the pouring hole 3.

When the continuous casting system 1 further includes the second conveying device 20, after the blockage detection unit 112 detects blockage of the pouring hole 3, the ignition control unit 114 may control the conveying device 10 so as to place the tip portion 33 at the heat source before the second conveying device 20 retracts the ladle shroud 5 from the mounting position P1. A state in which the ladle shroud 5 is retracted from the mounting position P1 means a state in which the ladle shroud 5 has moved from the mounting position P1 to the retracted position P2, which allows inserting the oxygen lance pipe 30 into the pouring hole 3. By performing in parallel the ignition of the tip portion 33 and the retraction of the ladle shroud 5 from the mounting position P1, the time from the detection of blockage of the pouring hole 3 to the opening of the pouring hole 3 can be further shortened.

The opening control unit 115 may control the conveying device 10 so that, before the second conveying device 20 retracts the ladle shroud 5 from the mounting position P1, the ignited tip portion 33 is oriented upward and placed at the standby position P11 next to the ladle shroud 5, and, after the second conveying device 20 retracts the ladle shroud 5 from the mounting position P1, the ignited tip portion 33 is placed into the pouring hole 3. For example, the opening control unit 115 checks whether the ladle shroud 5 has been retracted from the mounting position P1 based on the operational status of the second conveying device 20 controlled by the ladle shroud conveying control unit 113. The ignited oxygen lance pipe 30 can be quickly inserted once the ladle shroud 5 is retracted.

The control system 100 may further include a position detection unit 116. The position detection unit 116 detects the position of the pouring hole 3 based on the three-dimensional data acquired by the sensor 42. For example, the position detection unit 116 may, by matching a three-dimensional model of the pouring hole 3 and its surroundings stored in advance with the three-dimensional data, specify the position/posture of the three-dimensional model in the three-dimensional data and detect the position of the pouring hole 3 based on the specified position/posture of the three-dimensional model.

When the control system 100 further includes the position detection unit 116, the opening control unit 115 may place the tip portion 33 in the pouring hole 3 based on the position of the pouring hole 3 detected by the position detection unit 116. For example, the opening control unit 115 corrects the previously determined target position and target posture of the lance holding portion 11 (for example, the above-mentioned second target position, second target posture, third target position, and third target posture) so that the central axis of the insertion portion 32 aligns with the central axis of the pouring hole 3, based on the position detected by the position detection unit 116, and operates the lance holding portion 11 in accordance with the corrected target position and target posture. This allows the oxygen lance pipe 30 to be inserted into the pouring hole 3 with high accuracy.

The opening control unit 115 may control the conveying device 10 so that, based on the detection results of the force sensor 16, the thrust force of the tip portion 33 into the pouring hole 3 is limited while inserting the tip portion 33 into the pouring hole 3. For instance, the opening control unit 115 calculates the reaction force against insertion of the tip portion 33 based on the detection results from the force sensor 16. If the calculated reaction force exceeds a predetermined reaction-force threshold, the opening control unit 115 controls the conveying device 10 so as to reduce the displacement speed of the lance holding portion 11 until the reaction force becomes less than the reaction-force threshold. Damage to the lining of the pouring hole 3 due to collision with the oxygen lance pipe 30 can be readily avoided.

The opening control unit 115 may cause the conveying device 10 to align the tip portion 33 with respect to the pouring hole 3 based on the detection results of the force sensor 16. For example, the opening control unit 115 controls the conveying device 10 so as to, in a state where the tip portion 33 is inserted to a first depth in the pouring hole 3, bring the tip portion 33 into contact with multiple points on the inner surface of the pouring hole 3. For instance, the opening control unit 115 controls the conveying device 10 to displace the lance holding portion 11 in multiple horizontal directions until the tip portion 33 contacts the inner surface of the pouring hole 3, while confirming whether the tip portion 33 is contacting the inner surface of the pouring hole 3 based on the detection result of the force sensor 16. Each time the tip portion 33 contacts the inner surface of the pouring hole 3, the opening control unit 115 calculates the position of the tip portion 33 when contacting the inner surface of the pouring hole 3 based on the position of the lance holding portion 11. Thus, the position of the tip portion 33 is calculated for multiple contact points on the inner surface of the pouring hole 3.

The opening control unit 115 calculates the center position of the pouring hole 3 based on the positions of the tip portion 33 when contacting the inner surface of the pouring hole 3 at multiple points, and then controls the conveying device 10 so as to align the center position of the tip portion 33 with the center position of the pouring hole 3. For example, the opening control unit 115 controls the conveying device 10 so as to correct the current position and posture of the lance holding portion 11 so that the difference between the center position of the pouring hole 3 and the center position of the tip portion 33 becomes zero. The opening control unit 115 then controls the conveying device 10 so as to, while maintaining the state in which the center position of the tip portion 33 is aligned with the center position of the pouring hole 3, insert the tip portion 33 to a second depth deeper than the first depth. By aligning the center position of the tip portion 33 with the center position of the pouring hole 3 in a state where the tip portion 33 is inserted to the first depth, damage such as breakage of the lining until the tip portion 33 reaches the second depth can be avoided more reliably.

The control system 100 may further include a combustion detection unit 117. The combustion detection unit 117 detects whether combustion of the tip portion 33 is continuing based on image data acquired by the second sensor 43. For example, whether combustion of the tip portion 33 is continuing is detected by analyzing brightness or the like of the portion corresponding to the tip portion 33 in the image data.

When the control system 100 includes the combustion detection unit 117, the opening control unit 115 may control the conveying device 10 so as to relocate the tip portion 33 back to the position heated by the heat source if the combustion detection unit 117 detects that combustion of the tip portion 33 is no longer continuing. In this way, insertion of the oxygen lance pipe 30 in a state where its tip portion 33 is ignited can be carried out more reliably.

The control system 100 may further include a lance replacement control unit 118. The lance replacement control unit 118 controls the conveying device 10 so as to place a used oxygen lance pipe 30 at the gate 4, and also controls the conveying device 10 so as to have the lance holding portion 11 hold an unused oxygen lance pipe 30 in the rack 44. For example, after placing the used oxygen lance pipe 30 at the gate 4, the lance replacement control unit 118 controls the conveying device 10 so as to switch the lance holding portion 11 from the locked state to the unlocked state. Then, the lance replacement control unit 118 controls the conveying device 10 so as to connect the lance holding portion 11 to the tool adapter 15 attached to an unused oxygen lance pipe 30 in the rack 44, and to switch the lance holding portion 11 from the unlocked state to the locked state. By automating the replacement of the oxygen lance pipe 30 in the lance holding portion 11, further labor savings can be achieved in the oxygen opening operation.

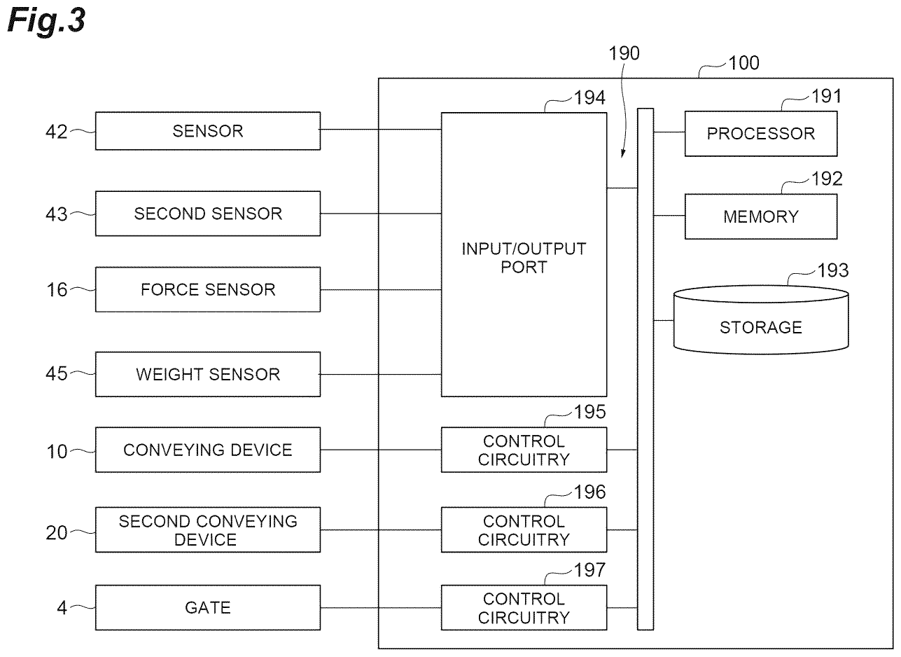

FIG. 3 is a block diagram illustrating an example hardware configuration of the control system. As illustrated in FIG. 3, the control system 100 includes circuitry 190. The circuitry 190 includes a processor 191, a memory 192, a storage 193, an input/output port 194, and control circuitry 195, 196, 197.

The storage 193 is formed of one or more nonvolatile memory devices such as a flash memory or a hard disk. The storage 193 stores a program that, when executed, causes the control system 100 to control the conveying device 10 so as to place the tip portion 33 in the position heated by the heat source for ignition, and to control the conveying device 10 so as to place the ignited tip portion 33 in the pouring hole 3 to open the blocked pouring hole 3. For example, the storage 193 stores a program for configuring each of the functional blocks described above in the control system 100.

The memory 192 is formed of one or more volatile memory devices such as random-access memory (RAM). The memory 192 temporarily stores the program loaded from the storage 193. The processor 191 is formed of one or more computing devices such as a CPU (Central Processing Unit) or a GPU (Graphics Processing Unit). By executing the program loaded into the memory 192, the processor 191 configures the control system 100 to function as each of the functional blocks described above. The calculation results of the processor 191 are temporarily stored in the memory 192.

The input/output port 194 inputs and outputs information to and from the sensor 42, the second sensor 43, the force sensor 16, the weight sensor 45, and the like, in response to a request from the processor 191. The control circuitry 195 operates the conveying device 10 in response to a request from the processor 191. The control circuitry 196 operates the second conveying device 20 in response to a request from the processor 191. The control circuitry 197 opens and closes the gate 4 in response to a request from the processor 191. The above-described hardware configuration is merely an example and can be modified. For example, the circuitry 190 may be divided into multiple circuits that can communicate with each other.

### Pouring Procedure

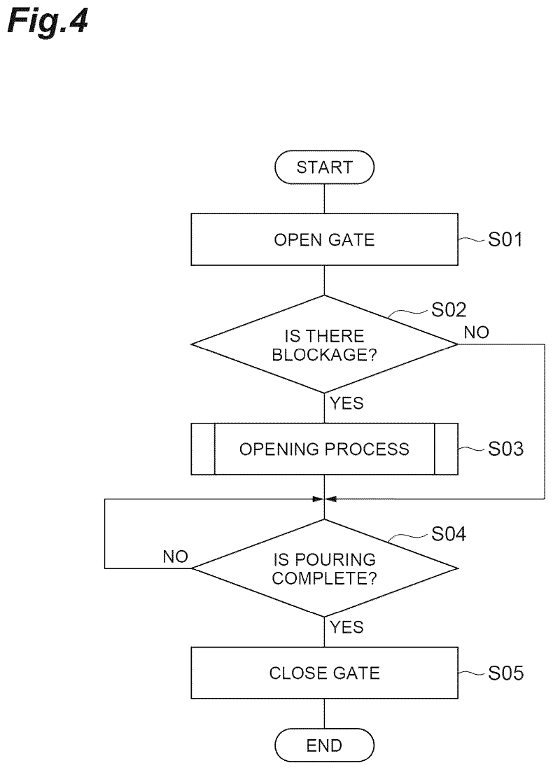

As an example of a pouring method, a pouring procedure performed by the continuous casting system 1 to pour molten steel from a ladle 2 to a tundish 6 is described. FIG. 4 is a flowchart illustrating the pouring procedure. As illustrated in FIG. 4, the control system 100 first executes steps S01 and S02. In step S01, the open/close control unit 111 opens the gate 4 to start discharging molten steel from the pouring hole 3. In step S02, the blockage detection unit 112 checks, based on the state of the gate 4 and changes in the weight of the tundish 6, whether the pouring hole 3 is blocked.

If blockage of the pouring hole 3 is detected in step S02, the control system 100 executes step S03. Details of step S03 will be described later. Then, the control system 100 executes step S04. If blockage of the pouring hole 3 is not detected in step S02, the control system 100 executes step S04 without executing step S03. In step S04, the open/close control unit 111 waits for completion of the pouring. For example, the open/close control unit 111 may wait until the pouring amount, starting from when the gate 4 was opened, reaches the planned amount, based on detection results from the tundish 6.

Next, the control system 100 executes step S05. In step S05, the open/close control unit 111 closes the gate 4, stopping the discharge of molten steel from the pouring hole 3.

### Oxygen Opening Procedure

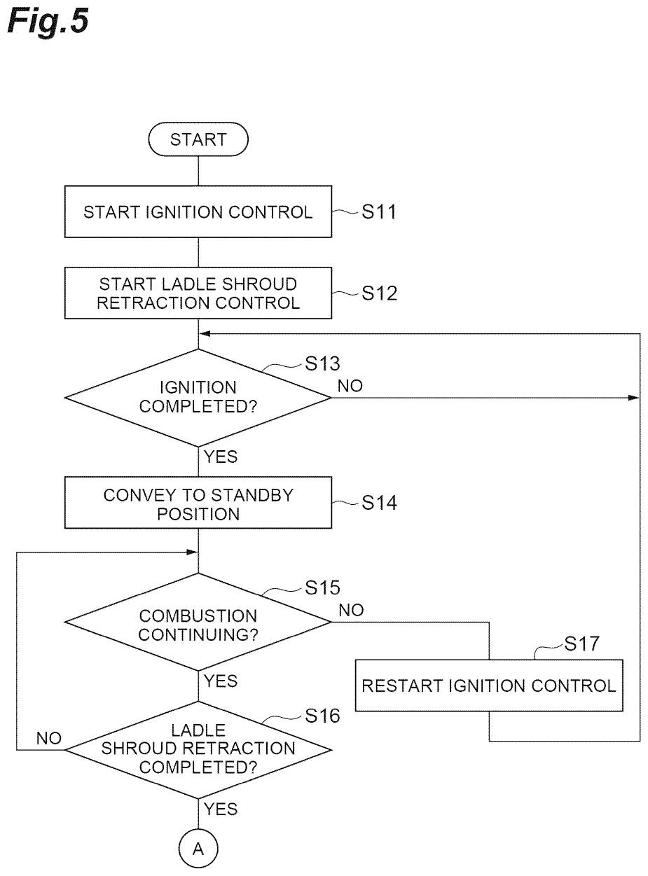

FIG. 5 is a flowchart illustrating an example oxygen opening procedure corresponding to step S03 described above. As illustrated in FIG. 5, the control system 100 first executes steps S11 and S12. In step S11, the ignition control unit 114 starts operation of the conveying device 10 to place the tip portion 33 in a position heated by the heat source for ignition. In step S12, the ladle shroud conveying control unit 113 starts the second conveying device 20 to convey the ladle shroud 5 from the mounting position P1 to the retracted position P2. Step S12 may be executed before step S11 or simultaneously with step S11.

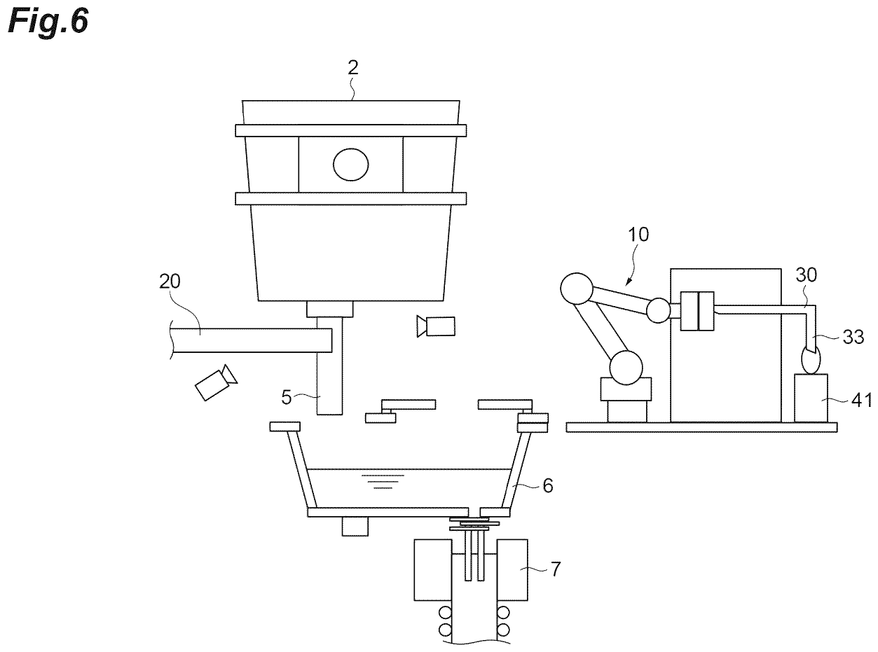

The control system 100 then executes step S13. In step S13, the ignition control unit 114 waits for the tip portion 33 to become ignited. For example, after the tip portion 33 has been placed at the position heated by the heat source, the ignition control unit 114 waits for a preset ignition time to elapse for ignition (see FIG. 6).

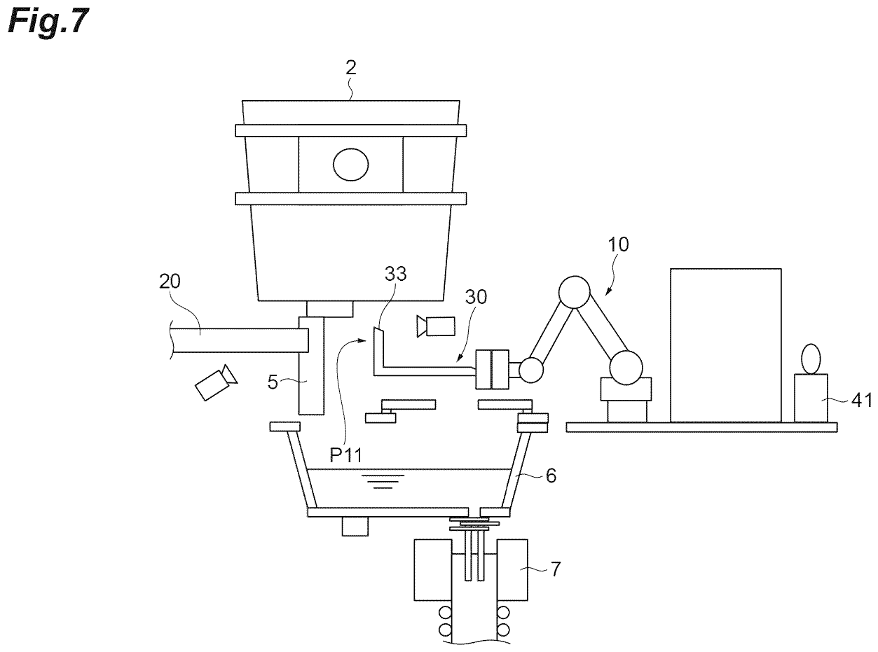

Next, the control system 100 executes steps S14 and S15. In step S14, the opening control unit 115 controls the conveying device 10 so as to orient the ignited tip portion 33 upward and place the tip portion 33 at the standby position P11 next to the ladle shroud 5 (see FIG. 7). In step S15, the combustion detection unit 117 detects, based on the image data acquired by the second sensor 43, whether combustion of the tip portion 33 is continuing.

If, in step S15, it is determined that combustion of the tip portion 33 is continuing, the control system 100 executes step S16. In step S16, the opening control unit 115 checks, based on the operational status of the second conveying device 20 controlled by the ladle shroud conveying control unit 113, whether retraction of the ladle shroud 5 from the mounting position P1 is complete.

If, in step S16, it is determined that retraction of the ladle shroud 5 from the mounting position P1 is not complete, the control system 100 returns to step S15. Thereafter, the process of waiting for the ladle shroud 5 to be retracted from the mounting position P1 continues until retraction of the ladle shroud 5 from the mounting position P1 is completed, while confirming that combustion of the tip portion 33 is still continuing. If, in step S15, it is determined that combustion of the tip portion 33 is not continuing, the control system 100 executes step S17. In step S17, the ignition control unit 114 starts operation of the conveying device 10 to relocate the tip portion 33 to the position heated by the heat source to ignite again. The control system 100 then returns to step S13.

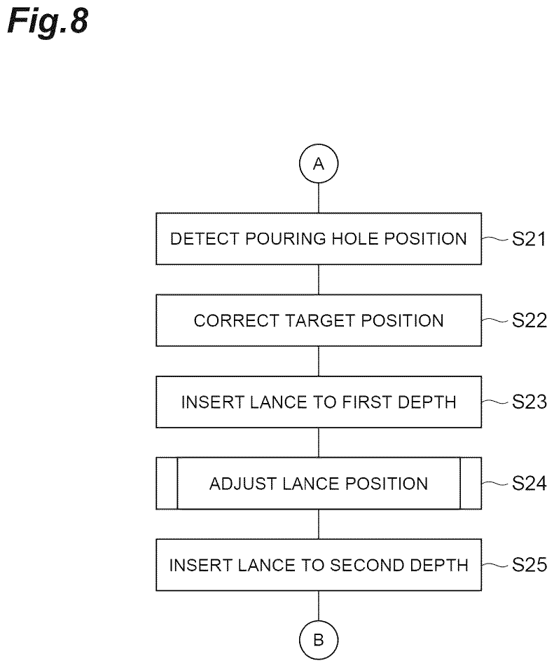

If, in step S16, it is determined that retraction of the ladle shroud 5 from the mounting position PI is complete, the control system 100 executes steps S21 and S22, as illustrated in FIG. 8. In step S21, the position detection unit 116 detects the position of the pouring hole 3 based on the three-dimensional data acquired by the sensor 42. In step S22, the opening control unit 115 corrects the predetermined target position and target posture so that the central axis of the insertion portion 32 aligns with the central axis of the pouring hole 3, based on the position detected by the position detection unit 116. For instance, the opening control unit 115 corrects the second target position and second target posture, which are set so that the upwardly oriented tip portion 33 extends toward the center of the pouring hole 3 from below, and the third target position and third target posture, which are set so as to place the tip portion 33 into the pouring hole 3.

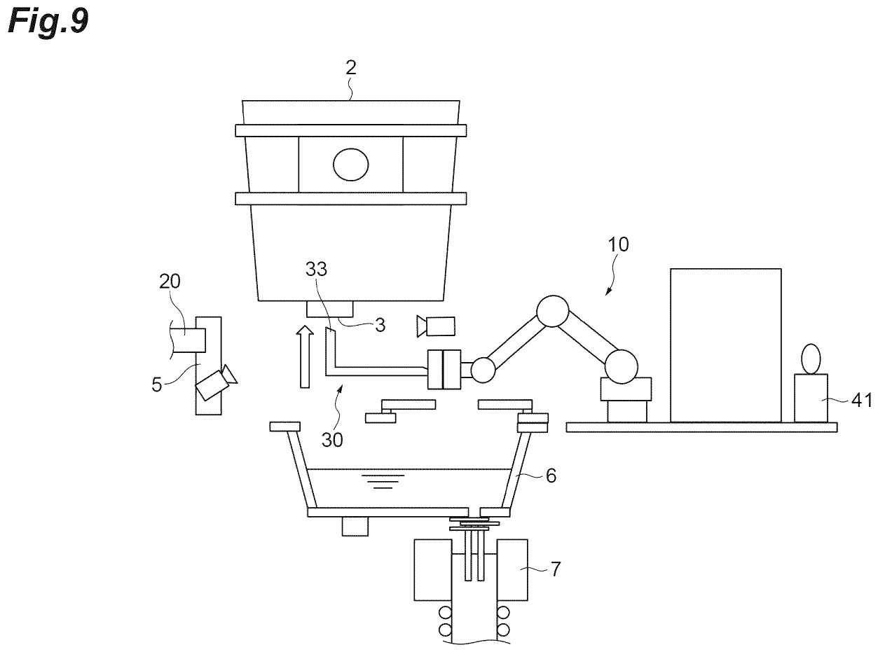

Next, the control system 100 executes steps S23, S24, and S25. In step S23, based on the corrected second target position, second target posture, third target position, and third target posture, the conveying device 10 is controlled so as to insert the tip portion 33 to a first depth inside the pouring hole 3 (see FIG. 9). In step S24, the conveying device 10 is controlled so that the tip portion 33 contacts multiple points on the inner surface of the pouring hole 3 and the pouring hole 3 is aligned with the pouring hole 3. Details of step S24 will be described later. In step S25, while maintaining the center position of the tip portion 33 aligned with the center position of the pouring hole 3, the opening control unit 115 controls the conveying device 10 so as to insert the tip portion 33 to a second depth that is deeper than the first depth.

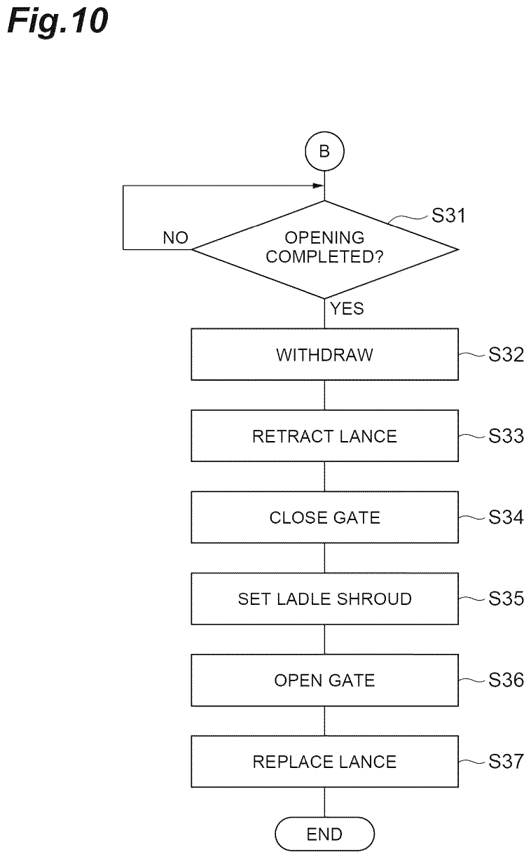

Next, as illustrated in FIG. 10, the control system 100 executes steps S31, S32, and S33. In step S31, the opening control unit 115 waits for the pouring hole 3 to be opened by the combustion heat of the oxygen lance pipe 30. For example, the opening control unit 115 may wait for a preset opening time to elapse for opening. The opening control unit 115 may wait, based on the detection results of the weight sensor 45, for an increase in the weight of the tundish 6 to begin once the pouring hole 3 is opened. The opening control unit 115 may wait for the commencement of molten steel discharge from the pouring hole 3 to be confirmed via a camera or the like that can detect molten steel outflow from the pouring hole 3.

In step S32, the opening control unit 115 controls the conveying device 10 to withdraw the oxygen lance pipe 30 from the pouring hole 3. For example, the opening control unit 115 controls the conveying device 10 to move the lance holding portion 11 back to the above-mentioned second target position and second target position at the time before the insertion of the oxygen lance pipe 30 into the pouring hole 3. In step S33, the opening control unit 115 controls the conveying device 10 so as to retract the oxygen lance pipe 30 from below the pouring hole 3.

Next, the control system 100 executes steps S34, S35, S36, and S37. In step S34, the open/close control unit 111 closes the gate 4 to stop discharge from the pouring hole 3 temporarily. In step S35, the ladle shroud conveying control unit 113 controls the second conveying device 20 to convey the ladle shroud 5 from the retracted position P2 to the mounting position P1. In step S36, the open/close control unit 111 opens the gate 4 to resume discharge from the pouring hole 3. In step S37, the lance replacement control unit 118 controls the conveying device 10 so as to place the used oxygen lance pipe 30 at the gate 4 and controls the conveying device 10 so as to have the lance holding portion 11 hold an unused oxygen lance pipe 30 stored in the rack 44. This completes the oxygen opening procedure.

position Adjustment Procedure

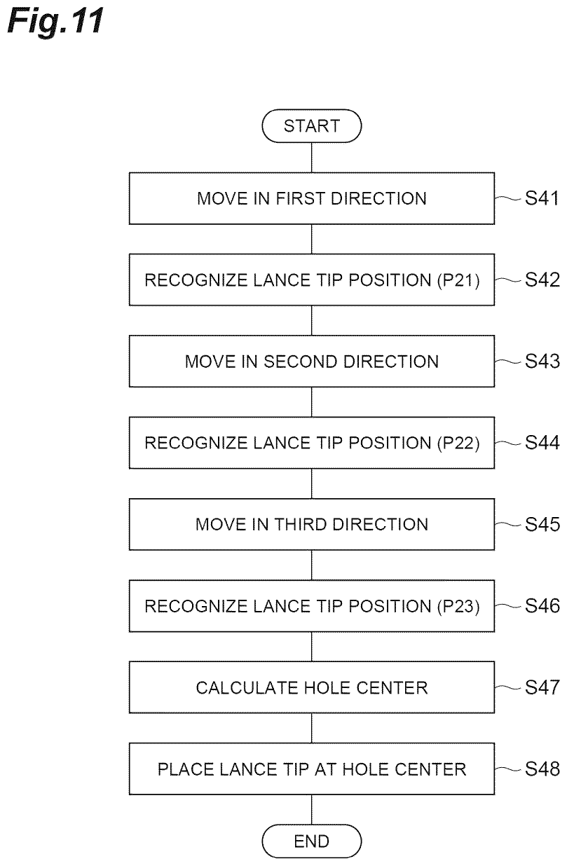

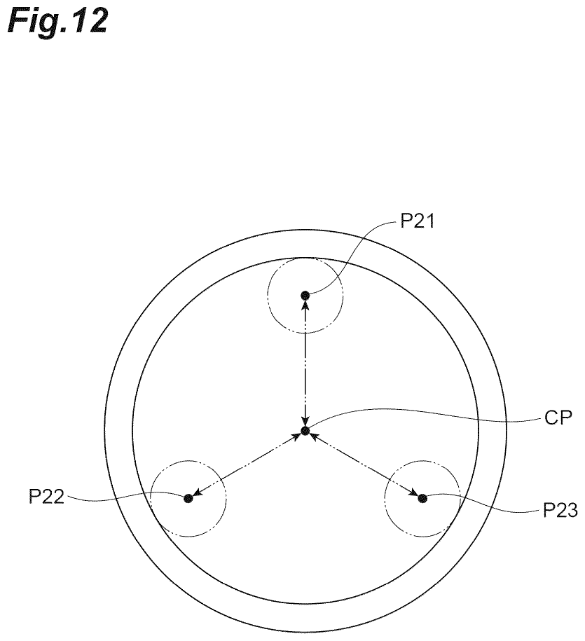

FIG. 11 is a flowchart illustrating an example position adjustment procedure for the oxygen lance pipe 30 in step S24. As illustrated in FIG. 11, the control system 100 first executes steps S41 and S42. In step S41, the opening control unit 115 controls the conveying device 10 to move the lance holding portion 11 horizontally in a first direction until the oxygen lance pipe 30 contacts the inner surface of the pouring hole 3. In step S42, the opening control unit 115 calculates the center position P21 of the tip portion 33, based on the current position and posture of the lance holding portion 11 (see FIG. 12).

The control system 100 then executes steps S43 and S44. In step S43, the opening control unit 115 controls the conveying device 10 to move the lance holding portion 11 horizontally in a second direction until the oxygen lance pipe 30 contacts the inner surface of the pouring hole 3. In step S44, the opening control unit 115 calculates the center position P22 of the tip portion 33 based on the current position and posture of the lance holding portion 11.

Next, the control system 100 executes steps S45 and S46. In step S45, the opening control unit 115 controls the conveying device 10 to move the lance holding portion 11 horizontally in a third direction until the oxygen lance pipe 30 contacts the inner surface of the pouring hole 3. In step S46, the opening control unit 115 calculates the center position P23 of the tip portion 33 based on the current position and posture of the lance holding portion 11.

Subsequently, the control system 100 executes steps S47 and S48. In step S47, based on the calculated center positions P21, P22, and P23, the opening control unit 115 calculates a center position CP of the pouring hole 3. For example, the opening control unit 115 may determine that the center position CP is a position equidistant from the center positions P21, P22, and P23. In step S48, the opening control unit 115 controls the conveying device 10 so as to align the center position of the tip portion 33 with the center position of the pouring hole 3. This completes the position adjustment procedure for the oxygen lance pipe 30.

### Summary

The above-described embodiment includes the following configuration.
(1) An oxygen opening device 8 including: a conveying device 10 configured to convey an oxygen lance pipe for supplying oxygen so as to place a tip portion of the oxygen lance pipe at a pouring hole 3 provided below a ladle 2 for molten steel and at a position heated by a heat source located away from the pouring hole 3; an ignition control unit 114 configured to control the conveying device 10 so as to place the tip portion at the position heated by the heat source for ignition; and an opening control unit 115 configured to control the conveying device 10 so as to place the ignited tip portion into the pouring hole 3 to open the pouring hole 3 that is blocked.

If the blocked pouring hole 3 is not opened in a timely manner, the molten steel in the ladle 2 may solidify without being discharged and, in some cases, it may become necessary to discard all the molten steel in the ladle 2 and even the ladle 2 itself. Thus, the task of opening the pouring hole 3 is critical. According to the present device, the oxygen lance pipe that has been ignited in advance is inserted into the pouring hole 3. Accordingly, the pouring hole 3 is opened in a timely manner by continued combustion of the oxygen lance pipe inside the pouring hole 3 without waiting for ignition inside the pouring hole 3. Therefore, the pouring hole 3 can be reliably opened in a timely manner with high reliability without being influenced by the remaining thermal energy in the pouring hole 3.
(2) The oxygen opening device 8 according to (1), wherein the ignition control unit 114 is configured to control the conveying device 10 so as to place the tip portion at the position heated by a heat source using molten steel stored outside the ladle 2 as the heat source. By efficiently using the heat of the molten steel for igniting the tip portion, the device structure can be simplified.
(3) The oxygen opening device 8 according to (1), further including an ignition device 41 disposed around the ladle 2, wherein the ignition control unit 114 is configured to control the conveying device 10 so as to place the tip portion at the position heated by the heat source, using the ignition device 41 as the heat source. Even in a situation where the amount of the molten steel is small and it is difficult to place the tip portion in the molten steel, the tip portion can be ignited.
(4) The oxygen opening device 8 according to any one of (1) to (3), wherein a ladle shroud 5 for guiding molten steel discharged from the pouring hole 3 is attached below the pouring hole 3, and wherein the opening control unit 115 is configured to control the conveying device 10 so as to place the ignited tip portion at a standby position P11 adjacent to the ladle shroud 5 with the tip portion oriented upward, and to place the tip portion into the pouring hole 3 after removal of the ladle shroud 5. Once the ladle shroud 5 is removed, the oxygen lance pipe can be quickly inserted into the pouring hole 3 and the pouring hole 3 can be opened more quickly.
(5) The oxygen opening device 8 according to any one of (1) to (4), further including a second conveying device 20 configured to convey the ladle shroud 5 for guiding the molten steel discharged from the pouring hole 3 between a mounting position below the pouring hole 3 and a retracted position retracted from the mounting position. This allows operations pertaining to the ladle shroud 5 and operations pertaining to the oxygen lance pipe to be performed in parallel. Accordingly, the pouring hole 3 can be opened more quickly.
(6) The oxygen opening device 8 according to (5), further including a blockage detection unit configured to detect blockage of the pouring hole 3 based on a state of a gate 4 for opening and closing the pouring hole 3 and a change in weight of a tundish 6 for accommodating the molten steel guided by the ladle shroud 5, wherein the ignition control unit 114 is configured to control the conveying device 10 so as to place the tip portion at the heat source after the blockage detection unit detects blockage of the pouring hole 3 and before the second conveying device 20 retracts the ladle shroud 5 from the mounting position. By performing in parallel the operation of igniting the tip portion and the operation of retracting the ladle shroud 5, the time from detection of blockage to the opening of hole can be further shortened.
(7) The oxygen opening device 8 according to (6), wherein the opening control unit 115 may control the conveying device 10 so as to: place the ignited tip portion at a standby position P11 next to the ladle shroud 5 with the ignited tip portion oriented upward before the second conveying device 20 retracts the ladle shroud 5 from the mounting position, and place the ignited tip portion into the pouring hole 3 after the second conveying device 20 retracts the ladle shroud 5 from the mounting position. Thus, the ignited oxygen lance pipe can be inserted more quickly after the ladle shroud 5 is retracted.
(8) The oxygen opening device 8 according to any one of (1) to (7), further including: a sensor 42 configured to acquire three-dimensional data of the pouring hole 3 from outside the ladle 2; and a position detection unit 116 configured to detect a position of the pouring hole 3 based on the three-dimensional data acquired by the sensor 42, wherein the opening control unit 115 is configured to place the tip portion in the pouring hole 3 based on the position of the pouring hole 3 detected by the position detection unit 116. The oxygen lance pipe can be inserted into the pouring hole 3 with high accuracy.
(9) The oxygen opening device 8 according to (8), further including: a second sensor 43 configured to acquire image data of the ignited tip portion; and a combustion detection unit 117 configured to detect whether combustion of the tip portion is continuing based on the image data acquired by the second sensor 43, wherein the ignition control unit 114 is configured to control the conveying device 10 so as to relocate the tip portion to the position heated by the heat source when the combustion detection unit 117 detects that the tip portion is not continuing to combust. Insertion of the oxygen lance pipe in a state where the tip portion is ignited can be executed more reliably.
(10) The oxygen opening device 8 according to any one of (1) to (9), wherein the conveying device 10 includes: a lance holding portion 11 configured to hold the oxygen lance pipe; a base portion 12 fixed below and around the ladle 2; and a multi-joint arm 13 connecting the lance holding portion 11 to the base portion 12 and configured to change a position and a posture of the lance holding portion 11 relative to the base portion 12. Thus, both the ignition and opening operations can be readily implemented by a single device.
(11) The oxygen opening device 8 according to (10), further including a force sensor 16 provided at the lance holding portion 11, wherein the opening control unit 115 is configured to control the conveying device 10, based on a detection result of the force sensor 16, so as to insert the tip portion into the pouring hole 3 while limiting thrust force of the tip portion into the pouring hole 3. Damage to the lining inside the pouring hole 3 due to collision with the oxygen lance pipe can be readily avoided.
(12) The oxygen opening device 8 according to (10) or (11), wherein the opening control unit 115 is configured to: control the conveying device 10 so as to bring the tip portion into contact with a plurality of points on an inner surface of the pouring hole 3 with the tip portion inserted to a first depth in the pouring hole 3; calculate a center position of the pouring hole 3 based on positions of the tip portion when contacting the plurality of points; control the conveying device 10 so as to align a center position of the tip portion with the center position of the pouring hole 3; and control the conveying device 10 so as to insert the tip portion to a second depth deeper than the first depth. By aligning the center position of the tip portion with the center position of the pouring hole 3 while the tip portion is inserted to the first depth, damage such as breakage of the lining during the process until the tip portion reaches the second depth can be avoided more reliably.
(13) The oxygen opening device 8 according to any one of (10) to (12), further including: a rack 44 for accommodating multiple oxygen lance pipes at a position away from under the ladle 2; and a lance replacement control unit 118 configured to control the conveying device 10 so as to place a used oxygen lance pipe into the rack 44, and to control the conveying device 10 so as to have the lance holding portion 11 hold an unused oxygen lance pipe stored in the rack 44. By automating the replacement of the oxygen lance pipe attached to the lance holding portion 11, further labor savings can be achieved in the oxygen opening operation.

### REFERENCE SIGNS LIST

2: ladle; 3: pouring hole; 4: gate; 5: ladle shroud; 6: tundish; 8: oxygen opening device; 10: conveying device; 11: lance holding portion; 12: base portion; 13: multi-joint arm; 41: ignition device; 42: sensor; 43: second sensor; P11: standby position; 16: force sensor; 44: rack; 20: second conveying device; 114: ignition control unit; 115: opening control unit; 116: position detection unit; 117: combustion detection unit; 118: lance replacement control unit.

1. An oxygen opening device comprising:
a conveying device configured to convey an oxygen lance pipe for supplying oxygen so as to place a tip portion of the oxygen lance pipe at a pouring hole provided below a ladle for molten steel and at a position heated by a heat source located away from the pouring hole;
a second conveying device configured to convey a ladle shroud for guiding molten steel discharged from the pouring hole between a mounting position below the pouring hole and a retracted position retracted from the mounting position;
circuitry configured to:
control the conveying device so as to place the tip portion at the position heated by the heat source for ignition; and
control the conveying device so as to, with the second conveying device having retracted the ladle shroud from the mounting position, place the ignited tip portion into the pouring hole to open the pouring hole that is blocked.

2. The oxygen opening device according to claim 1,
wherein the circuitry is configured to control the conveying device so as to place the tip portion at the position heated by the heat source using molten steel stored outside the ladle as the heat source.

3. The oxygen opening device according to claim 1, further comprising an ignition device disposed around the ladle,
wherein the circuitry is configured to control the conveying device so as to place the tip portion at the position heated by the heat source using the ignition device as the heat source.

4. The oxygen opening device according to claim 1,
wherein a ladle shroud for guiding the molten steel discharged from the pouring hole is attached below the pouring hole, and
wherein the circuitry is configured to control the conveying device so as to place the ignited tip portion at a standby position adjacent to the ladle shroud with the tip portion oriented upward, and to place the tip portion into the pouring hole after removal of the ladle shroud.

5. The oxygen opening device according to claim 1, wherein the circuitry is configured to:
detect blockage of the pouring hole based on a state of a gate for opening and closing the pouring hole and a change in weight of a tundish for accommodating the molten steel guided by the ladle shroud; and
control the conveying device so as to place the tip portion at the heat source after detecting blockage of the pouring hole and before the second conveying device retracts the ladle shroud from the mounting position.

6. The oxygen opening device according to claim 5,
wherein the circuitry is configured to control the conveying device so as to:
place the ignited tip portion at a standby position adjacent to the ladle shroud with the ignited tip portion oriented upward before the second conveying device retracts the ladle shroud from the mounting position; and
place the ignited tip portion into the pouring hole after the second conveying device retracts the ladle shroud from the mounting position.

7. The oxygen opening device according to claim 1, further comprising:
a sensor configured to acquire three-dimensional data of the pouring hole from outside the ladle; and
wherein the circuitry is configured to:
detect a position of the pouring hole based on the three-dimensional data acquired by the sensor; and
place the tip portion in the pouring hole based on the position of the pouring hole detected by the position detection unit.

8. The oxygen opening device according to claim 7, further comprising:
a second sensor configured to acquire image data of the ignited tip portion; and
wherein the circuitry is configured to:
detect whether combustion of the tip portion is continuing based on the image data acquired by the second sensor; and
control the conveying device so as to relocate the tip portion to the position heated by the heat source when the combustion detection unit detects that the tip portion is not continuing to combust.

9. The oxygen opening device according to claim 1, wherein the conveying device comprises:
a lance holding portion configured to hold the oxygen lance pipe;
a base portion fixed below and around the ladle; and
a multi-joint arm connecting the lance holding portion to the base portion and configured to change a position and a posture of the lance holding portion relative to the base portion.

10. The oxygen opening device according to claim 9, further comprising a force sensor provided at the lance holding portion,
wherein the circuitry is configured to control the conveying device, based on a detection result of the force sensor, so as to insert the tip portion into the pouring hole while limiting thrust force of the tip portion into the pouring hole.

11. The oxygen opening device according to claim 9, wherein the circuitry is configured to:
control the conveying device so as to bring the tip portion into contact with a plurality of points of an inner surface of the pouring hole with the tip portion inserted to a first depth in the pouring hole;
calculate a center position of the pouring hole based on positions of the tip portion when contacting the plurality of points;
control the conveying device so as to align a center position of the tip portion with the center position of the pouring hole; and
control the conveying device so as to insert the tip portion to a second depth deeper than the first depth.

12. The oxygen opening device according to claim 9, further comprising:
a rack for accommodating a plurality of oxygen lance pipes at a position away from under the ladle, and
wherein the circuitry is configured to control the conveying device so as to place a used oxygen lance pipe into the rack, and to control the conveying device so as to have the lance holding portion hold an unused oxygen lance pipe stored in the rack.
